(19) United States
(12) Patent Application Publication
(10) Pub. No.: US 2004/0173015 A1
(43) Pub. Date: Sep. 9, 2004

(54) Apparatus for measuring radial displacement of a wheel

(76) Inventor: Boris R. Teper, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/772,891

(22) Filed: Feb. 5, 2004

Related U.S. Application Data
(60) Provisional application No. 60/446,464, filed on Feb. 11, 2003.

(51) Int. Cl. G01M 17/02

(52) U.S. Cl. 73/146

(57) ABSTRACT

An apparatus for measuring radial displacement of a wheel having upper and lower beads, i.e. beads, includes a mount assembly for securing and rotating the wheel. A first element is pivotably connected to a second element for simultaneously engaging the beads. The first element is moved with respect to the axis through pivoting motion of the second element in response to the radial displacements of the beads to generate a signal. The first element is operably connected to a first sensor for measuring the radial displacements of the beads. A tool for marking the wheel is operably connected to the first element. A controller is electronically connected to the mount assembly, the first element, and the first sensor, and the tool for integrating the signal and marking the wheel between the radial displacements of the beads.

### RELATED APPLICATION

The subject patent application claims priority to and all the benefits of U.S. Provisional Patent Application Serial No. 60/446,464 filed on Feb. 11, 2003.

### FIELD OF THE INVENTION

This invention relates generally to a system for measuring radial displacement of a wheel having two beads for engaging a tire.

### BACKGROUND OF THE INVENTION

Motor vehicles are commonly supported by pneumatic tires supported on the respective wheels. It is well known that non-uniform tire and wheel assemblies contribute significantly to noise and vibration of the motor vehicle. A common cause of noise and vibration is the tire and wheel assembly that is not substantially round, which results in what is commonly referred to as smooth road shake, resulting in the undesirable vibration of the motor vehicle. To improve the potential for manufacturing the tire and wheel assembly that is substantially round, the concentricity of the tire and of the wheel is determined prior to assembling the tire with the wheel. To produce a substantially round tire and wheel assembly, the tire is aligned upon the wheel so that a maximum wheel deviation is aligned with a minimum tire deviation, causing the two deviations to cancel out. During the assembly process, the concentricity of the wheel is measured, and the maximum deviation is marked with a die. Likewise, the concentricity of the tire is measured and a minimum deviation is marked with a die. While mating the tire to the wheel, the markings are aligned so that the maximum wheel deviation and the minimum tire deviation are positioned adjacent, attempting to cancel out the tire and wheel deviations.

Manual measurement of the concentricity and radial displacement of the wheel can be time consuming and subject to human error. It has become desirable to process an ever-increasing variety of the wheels, through a single workstation. The art is replete with various workstations and apparatuses for measuring the concentricity of a wheel. The U.S. Pat. No. 3,951,563 to Ravenhall; U.S. Pat. No. 5,074,048 to Yokomizo et al.; and U.S. Pat. No. 6,173,213 to Amiguet et al. teach various devices and workstations for measuring concentricity of wheels.

The U.S. Pat. No. 3,951,563 to Ravenhall, for example, teaches a device for measuring the radial displacements of upper and lower beads of a wheel. The device includes separate sensors that are placed against each bead of the wheel, being axially rotated to measure the wheel's radial displacement. The measurements of the upper and lower beads are converted into step impulses by an encoder, which are subsequently fed into a digital computer. The sensors are designed to measure the radial displacement of the respective upper and lower beads with respect to the axis of the wheel. The signals produced by each sensor are transformed to the digital computer via a digital converter. The signals are converted and forwarded to the computer by an encoder, which correlates each step input to a particular angle of rotation of the wheel. The sensors require separate calibration.

In addition to the aforementioned patents, the related art teaches various other devices, which are presently used to determine radial displacement of the wheel. One such device generates a visual analysis conducted by a machine of the two surfaces that mate with the beads of a tire. This type of device is known to be expensive and difficult to calibrate, because two electronic mechanisms are required to measure radial displacement of each of the two surfaces, i.e. upper and lower beads that mate with the respective tire beads. Other devices are known to use mechanical measurements, but still require two measuring instruments for each of the two surfaces that mate with the tire beads. Therefore, the aforementioned devices are also difficult to calibrate.

There is a constant need in the area of the automotive industry for an improved system for measuring radial displacement of a wheel. Therefore, it would be desirable to produce an apparatus for measuring radial displacement of a wheel that is simple to manufacture and easy to calibrate.

### SUMMARY OF THE INVENTION

An apparatus for measuring radial displacement of a wheel having first and second beads each having a peripheral surface circumscribing an axis, includes a mount assembly for rotating the wheel around said axis. A sensing device of the apparatus is movable radially relative to the axis. A bead engaging element is pivotably connected to the sensing device for simultaneously engaging the first and second beads. The bead engaging element moves the sensing device with respect to the axis as the first and second beads vary in radial distance from the axis around the wheel. The moving motion of the sensing device, when the sensing device moves radially relative to the axis, facilitates detection of the combined offset of the first and second beads from the axis to generate a first signal representing the average radial displacement of the first and second beads.

An advantage of an inventive sensor of the present invention is to provide an apparatus to solve the problems associated with the prior art devices for measuring radial displacement of a wheel by virtue of its simplistic design, wherein a bead engaging element pivotably connected to a sensing device detects the combined offset of first and second beads of the wheel from an axis.

Another advantage of the present invention is to provide an apparatus having a single sensor operably connected to the bead engaging element, thereby eliminating prior art dual sensors design, each of which must be calibrated in order to accurately determine the radial displacement of the wheel.

Therefore, a software performing calculations is simplified relative to a software performing calculations associated with the prior art dual sensor design.

Further, because only one sensor needs to be calibrated, the accuracy of measurements is increased unlike the prior art dual sensor design, which introduces measurement variability by virtue of making two measurements.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a sectional side view of an apparatus for measuring radial displacement of a wheel;

FIG. 2 is a top and partially cross sectional view of a motor mount assembly for the apparatus;

FIG. 3 is a cross sectional fragmental view of a sensor tower of the apparatus having a horizontal member operably connected with a vertical member and presenting abutting engagement with the wheel;

FIG. 4 is a perspective and partially broken view of the sensor tower having the vertical member diverging with respect to the horizontal member;

FIG. 5 is a perspective and partially broken view of an actuator operably connected to the sensor device, wherein the sensor tower is moved away from a mount device holding the wheel; and

FIG. 6 is another perspective partially broken view of the actuator operably connected to the sensor device, wherein the sensor tower is moved to the mount device holding the wheel.

### DETAILED DESCRIPTION OF THE PREFERRED EMBODIMENT

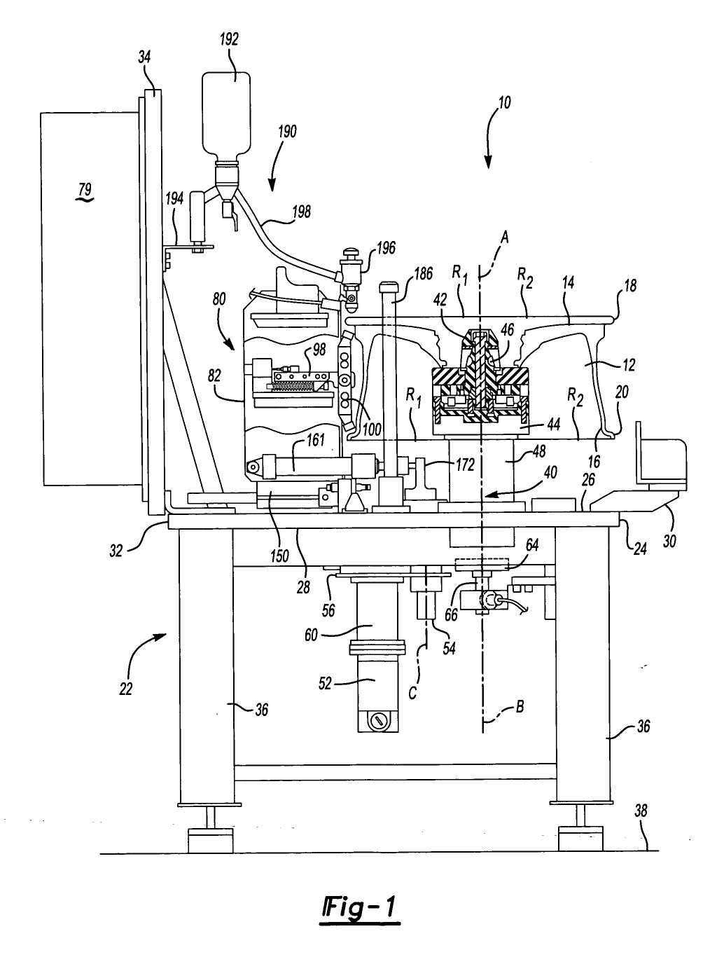

Referring to FIG. 1, wherein like numerals indicate like or corresponding parts, an apparatus of the present invention is generally shown at 10. The apparatus 10 determines radial displacement of a wheel 12 having upper 14 and lower 16 beads each presenting a peripheral surfaces 18, 20 circumscribing an axis A, and first radius R1 and second radius R2 of the upper 14 and lower 16 beads, defined between the axis A and the peripheral surfaces 18, 20. The apparatus 10 presents a support frame, generally shown at 22, having a work surface 24 having upper 26 and lower 28 sides, front 30 and rear 32 ends. A wall 34 is connected to the work surface 24 at the rear end 32. A plurality of mounting members, i.e. legs 36 are connected to and extend from the lower side 28 of the work surface 24 to secure the support frame 22 onto a floor 38.

A mount assembly, generally indicated at 40, over which the wheel 12 is secured, is operably connected to the work surface 24 for rotating the wheel 12 about the axis A. The mount assembly 40 includes a spring mount 42 axially aligned with a spindle plate 44. The wheel 12 is supported by the spindle plate 44 and secured to the mount assembly 40 by the spring mount 42. The spring mount 42 includes a plurality of slots (not shown) located radially about the spring mount 42 much like a collet. Disposed within the spring mount 42 is a bladder 46 or equivalent inflatable member providing an enclosure capable of being de-pressurized, thereby retract the spring mount 42 radially inwardly to allow the wheel 12 to slide freely over the spring mount 42. Otherwise, the spring mount 42 is biased radially outwardly to securely engage the wheel 12. The mount assembly 40 is supported by a spindle 48 projecting upwardly from the work surface 24. A motion device 52, i.e. motor is disposed beneath the work surface 24 to provide radial movement to the mount assembly 40 and therefore the wheel 12.

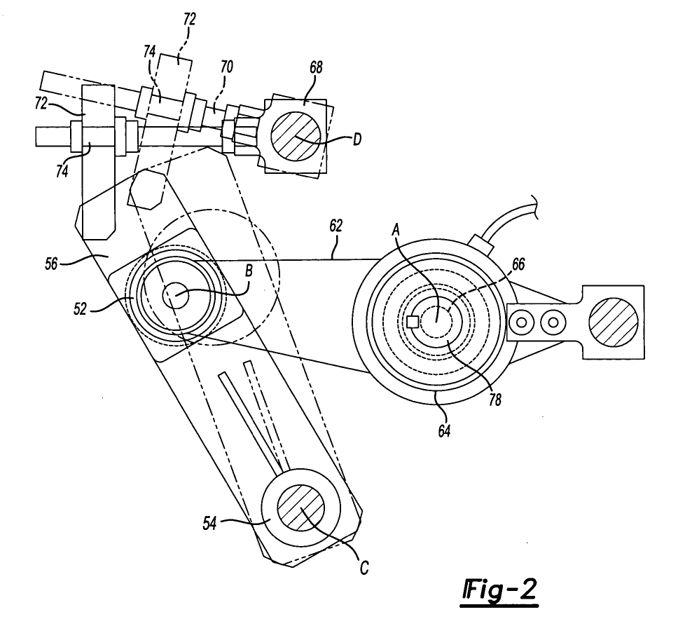

As best shown in FIGS. 1 and 2, a motion device 52, i.e. motor is disposed beneath the work surface 24 to provide radial movement to the mount assembly 40 and therefore the wheel 12. The motor 52 presents an axis B and is suspended from the work surface 34 by a pivotable motor mount 54 presenting an axis C. A motor arm 56, defined by a plate, extends from the motor mount 54 and is operably connected with the motor 52. The motor arm 56 is pivotable around the axis C defined by the motor mount 54. Therefore, the location of the motor 52 may be altered as needed. A pulley 60 circumscribing the axis B, is rotationally driven by the motor 52 to provide driving motion to a belt 62. The belt 62 transfers rotational movement from the motor 52 to a second pulley 64, which in turn transfers rotational movement to a shaft 66. The shaft 66 transfers rotational movement to the spindle 48 of the mount assembly 40, which in turn transfers rotational movement to the wheel 12. Tension of the belt 62 is maintained by virtue of pivotal movement of the motor 52 with respect to axis C of the motor mount 54. An adjustable block 68 presents an axis D and is operably connected to the work surface 24. A lever 70 extends from the adjustable block 68 in a cantilevered fashion. A link 72 is rotatably connected to the motor arm 56. The link 72 includes a cylindrical core 74 cooperably connected to the link 72. The cylindrical core 74 is slidably movable along the lever 70 to move the motor arm 56 toward and away from the second pulley 64 to secure the motor 52 in the desired position. The cylindrical core 74 includes mechanical means (not shown) for securing the link 72 with the lever 70 at the desired position. Therefore, the belt 62 is easily replaced.

A second sensor, i.e. encoder 78 is axially aligned with the shaft 66 and is supported by an encoder bracket (not shown). The encoder 78 tracks a phase angle, i.e. rotational location of the wheel 12 to identify the exact location of the wheel deviation, i.e. radial displacement. The encoder 78, coupled to the spindle 48 detects a phase angle of rotation of the spindle 48. The encoder 78 operates as is known to those skilled in the art of radial location determination. The encoder 78 is electronically connected to a controller 79.

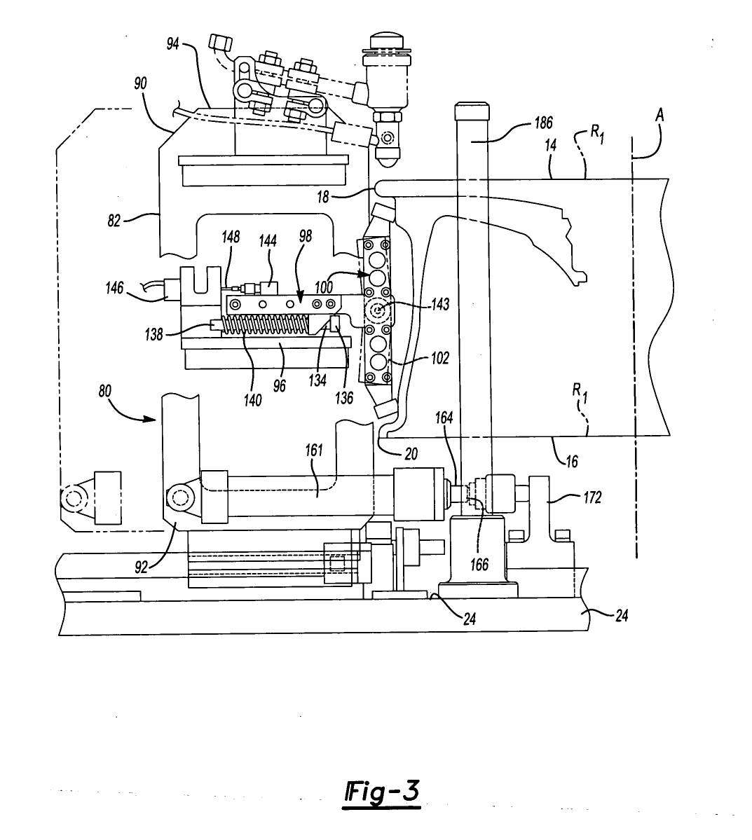

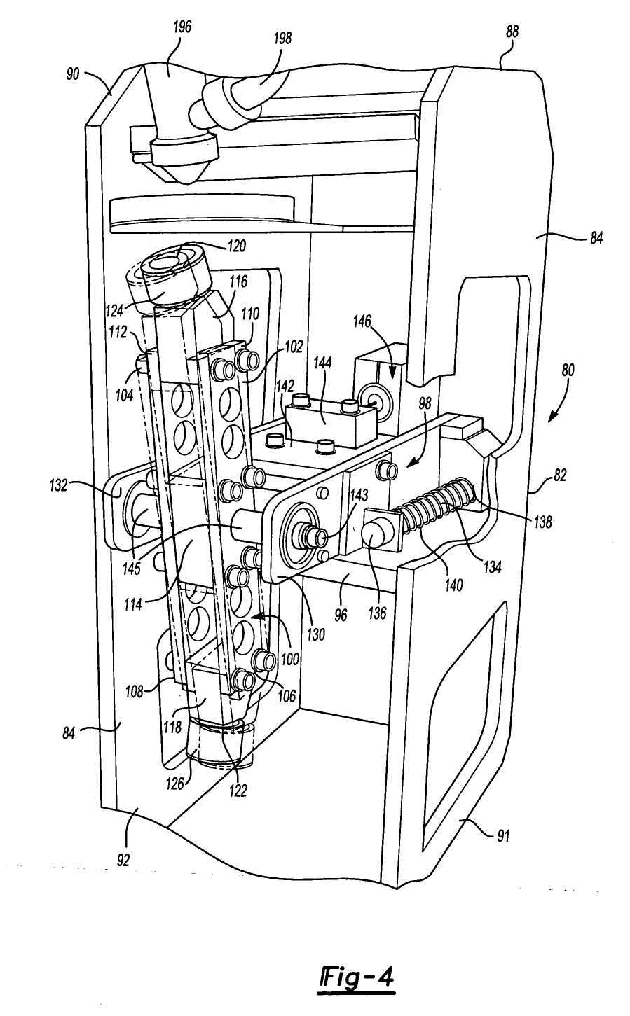

Referring to FIGS. 3 and 4, a supporting element, i.e. sensor tower, generally shown at 80, will now be discussed. The sensor tower 80 is defined by a frame 82 having side walls 84, 86 presenting upper 88, 90 and lower 91, 92 ends, respectively. A top portion 94 of the sensor tower 80 extends between the side walls 84, 86 at the upper ends 88, 90 interconnecting one with the other. A support plate 96 extends between the side walls 84, 86 interconnecting one with the other for supporting a sensing device, i.e. horizontal member, generally indicated at 98, slidably-disposed on the support plate 96 and a bead engaging element, i.e. vertical member, generally indicated at 100, pivotably connected to the horizontal member 98.

The vertical member 100 extends perpendicularly with respect to the horizontal member 98. diverging therefrom in response to the radial displacements of the upper and lower beads 14, 16, respectively, as an offset between the upper 14 and lower 16 beads results from a difference in length between the first radius R1 and the second radius R2 of the upper bead 14 and the lower bead 16 with respect to the axis A, as the upper 14 and lower 16 beads vary in radial distance from the axis A around the wheel 12.

As best shown in FIG. 4, the vertical member 100 includes a pair of plates 102, 104 presenting extremities 106, 108, 110, and 112, respectively. The plates 102, 104 are spaced apart by a core member 114 for facilitating the pivotable connection with the horizontal member 98. The vertical member 100 is pivotably connected to the horizontal member 98 to simultaneously engage the upper 14 and lower 16 beads. The vertical member 100 moves the horizontal member 98 with respect to the axis A through mechanical motion of the vertical member 100 in response to difference between the radial displacements of the upper 14 and lower 16 beads, as the upper 14 and lower 16 beads vary in radial distance from the axis A around the wheel 12.

A pair of support tips 116, 118 having necks 120, 122, respectively, are disposed between and are connected to the plates 102, 104 at each of the extremities 106, 108, 110, 112, respectively. A pair of rollers 124, 126, i.e. feelers are pivotably connected to the respective support tips 120, 122 for facilitating the abutting engagement of the vertical member 100 with the upper 14 and lower 16 beads of the wheel 12. The location of the radial displacement of the respective upper 14 and lower 16 beads of the wheel 12, as determined by the encoder 78, is signaled to the controller 79 through a cable (not shown).

The horizontal member 98 includes a pair of spaced walls 130, 132. A pair of shafts, only one is shown at 134 in FIGS. 3 and 4, have terminal ends 136, 138. Each shaft 134 is connected to the side walls 84, 86 of the support structure 82 of the sensor tower 80 at one terminal end 136 and is slidably connected to the horizontal member 98 at another terminal end 138. A resilient member 140, i.e. spring, is annularly engaged about each shaft 134 and disposed between the terminal ends 136, 138 of each shaft 134. The spring 140 generates biasing force, thereby biasing the vertical member 100 via the horizontal member 98 against the wheel 12. While only the aforementioned spring 140 has been discussed, biasing force may be generated by various devices, or equivalents as known to those of skill in the art.

A link 142, extends between the walls 130, 132 of the horizontal member 98, interconnecting the walls 130, 132. A projection member 144 is connected to the link 142. A pin 143, extending through the walls 130, 132, plates 102, 104, and the core portion 114, facilitates pivotable motion of the vertical member 100 with respect to the horizontal member 98. A pair of bushings 145 surround the pin 143 to prevent radial disposition of the vertical member 100 relative to the horizontal member 98.

A first sensor, i.e. linear variable differential transformer (LVDT), generally indicated at 146, is connected to and extends from the projection member 144. The LVDT 146 is operably connected to the controller 79. The LVDT 146 presents a sensitive measuring device that produce an electrical output signal precisely proportional to the mechanical displacement of the vertical member 100 mechanically connected to the horizontal member 98. Based on the linear variable differential transformer (LVDT) principle, the performance of the LVDT 146 depends on inductance effects that do not involve flexing wires or sliding electrical contacts. The LVDT 146 includes various components not shown in the present invention, such as, for example coils, which are magnetically shielded, and are cased in hardened stainless-steel housings. The LVDT 146 has an internal spring to continuously push an armature presenting a probe end to its fullest possible extension, thereby maintaining light yet reliable contact with a measured object, i.e. the wheel 12. The LVDT 146 produce an AC output voltage proportional to the mechanical displacement of a small iron core. One primary and two secondary coils are symmetrically arranged to form a hollow cylinder. A magnetic nickel-iron core, i.e. core, supported by a nonmagnetic push rod 148, moves axially within the cylinder in response to mechanical displacement of the horizontal member 98. With excitation of the primary coil, induced voltages will appear in the secondary coils. Because of the symmetry of magnetic coupling to the primary, these secondary induced voltages are equal when the core is in the central, i.e. null or electric zero position. When the secondary coils are connected in series opposition, the secondary voltages will cancel and ideally there will be no net output voltage. If, however, the core is displaced from the null position, in either direction, one secondary voltage will increase, while the other decreases, thereby producing an output conforming to the accurate characteristic.

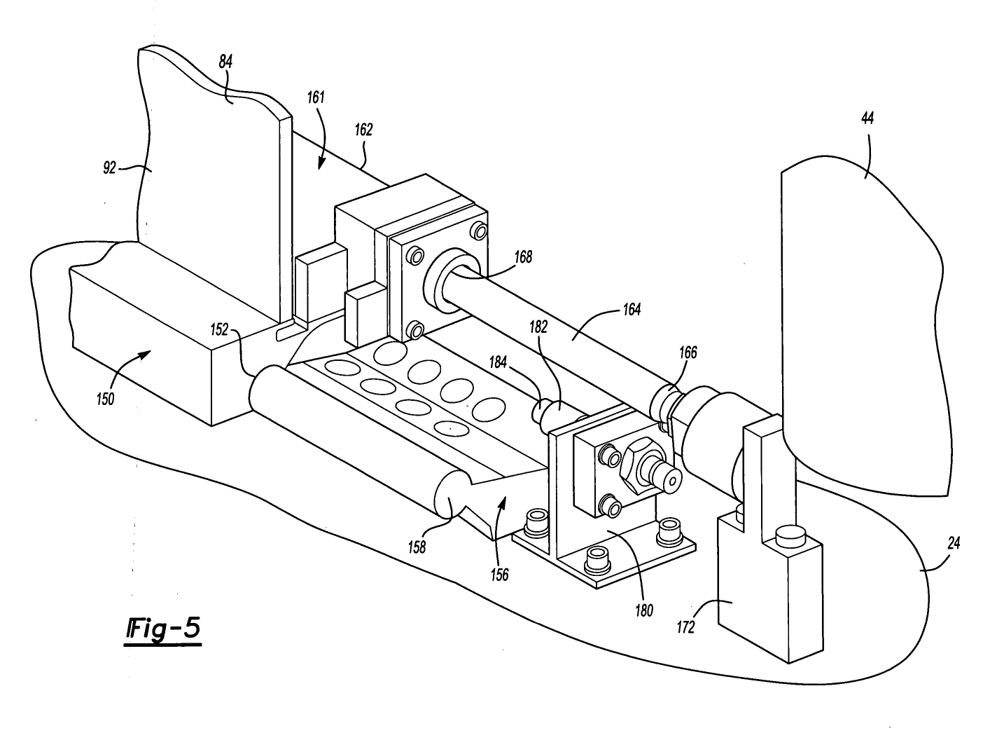

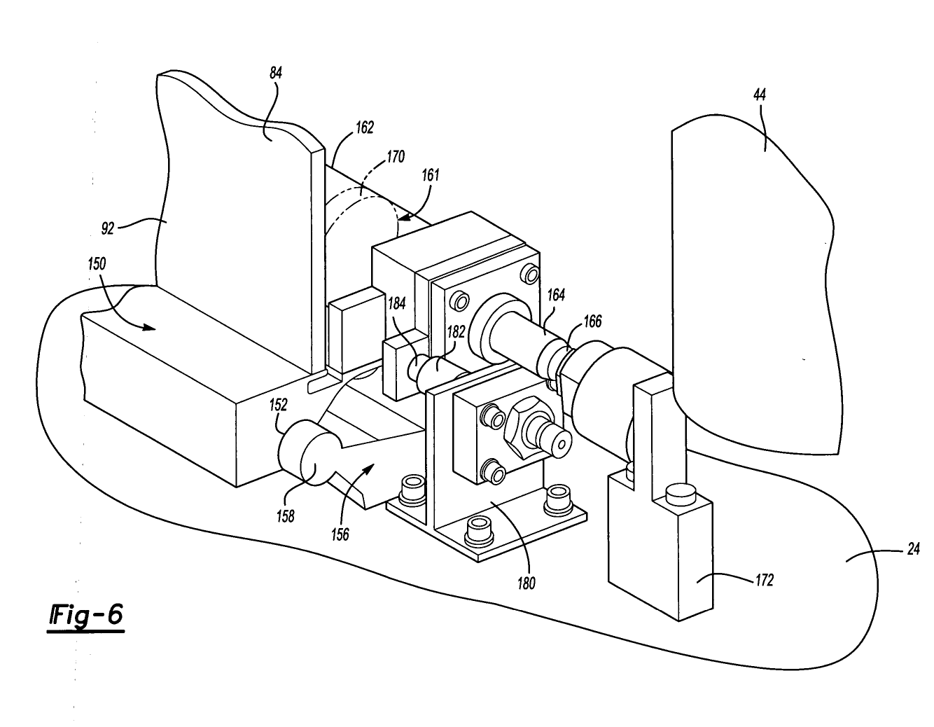

Referring to FIGS. 5 and 6, a carriage, generally indicated at 150, moves the sensor tower 80 to and from the wheel 12. The carriage 150 is operably connected to the side walls 84, 86 at the lower ends 91, 92 for moving the sensor tower 80 to and from abutting engagement with the wheel 12. The carriage 150 presents a pair of tracks 152 (only one is shown), defined therein. A pair of integrated rails, generally indicated at 156, are connected to the work surface 24. Each rail 156 presents first 158 and second 160 ends and a surface complementary to the surface of the tracks 152 for facilitating a slidable motion of the carriage 150 along the rails 156.

A pneumatic actuator, generally indicated at 161, is operably connected to the carriage 150 for moving the sensor tower 80 to and from the mount assembly 40. The pneumatic actuator 161 presents a housing 162 that includes a rod 164 having first 166 and second 168 ends, a piston 170, connected to the rod 164 at the first end 166. An anchor device 172 is connected to the work surface 24 extending outwardly therefrom. The anchor device 172 is connected with the second end 168 of the rod 164 for facilitating slidable movement of the sensor tower 80 to and from the mount assembly 40. Inward and outward ports (not shown) are defined in the housing 162. Inward and outward pressure lines (not shown) are operably connected to the inward and outward ports, respectively. The outward pressure line pulls air out of the housing 162 reducing air pressure, i.e. P1 inside the housing 162 thereby moving the piston 170 inwardly. In addition, the inward pressure line forces air into the housing 162 increasing the air pressure, i.e. P2 inside the housing 162 thereby moving the piston 170 outwardly. If P1 is higher than P2, the rod 164 is pushed outwardly from the housing 162, thereby moving the sensor tower 80 away from the mount assembly 40. However, if P1 is less than P2, the rod 164 is pulled inwardly to the housing 162, thereby moving the sensor tower 80 to the mount assembly 40 for facilitating the abutting engagement of the vertical member 100 with the upper 14 and lower 16 beads of the wheel 12. While only the aforementioned pneumatic actuator 161 have been discussed, P1 and P2 may be generated by spring devices, or equivalents, such as, for example, hydraulic, and electronic devices, as known to those skilled in the art.

Referring back to FIGS. 5 and 6, a stopper device 180 is connected to the work surface 24 extending upwardly from the work surface 24. The stopper device 180 is engaged at the first end 158 of the integrated rails 156 for controlling a stroke of the sensor tower 80 with respect to the mount assembly 40. The stopper device 180 includes a finger 182 having a resilient head 184 to facilitate frictional engagement with the sensor tower 80. In addition to the stopper 180, a pair of positioning bars, only one is shown at 186 in FIGS. 1 and 3, opposed one the other, may be included to secure the wheel 12 in a desired location upon the mount assembly 40 so that the sensor tower 80 can engage the upper 14 and lower 16 beads by forming a V-block to receive the wheel 12, as best shown in FIGS. 1 and 3. The positioning bars 186 also protect the sensor tower 80 from being damaged while positioning the wheel 12 upon the mount assembly 40. The positioning bars 186 extend upwardly from the work surface 24 generally between the mount assembly 40 and the sensor tower 80. To locate the wheel 12 accurately upon the mount assembly 40, the wheel 12 is positioned in an abutting relationship with the positioning bars 186, which locates a central aperture of the wheel 12 directly above the mount assembly 40. Once the wheel 12 is positioned in abutting relationship with the positioning bars 186, the wheel 12 can be lowered into engagement with the mount assembly 40.

An applicator, i.e. tool for marking the upper bead 14 of the wheel 12 is shown at 190 in FIG. 1. The tool 190 is operably connected to the top portion 94 and is operably connected to the controller 79 for receiving a forth signal for placing a mark onto the upper bead 14 of the wheel 12. A die reservoir 192 is supported by reservoir bracket 194 that is mounted on the wall 34. The die reservoir 192 is fluidly connected to a die nozzle 196 by a hose or tube 198. The die nozzle 196 points downwardly from above the wheel 12 to apply a marking of die to the wheel 12 surface at a desired location. While only the aforementioned tool 190 for placing the mark, i.e. paint based mark, have been discussed, the mark may be placed by drilling, or other methods, known to those skilled in the art.

The controller 79 is disposed upon an opposite side of the wall 34. The controller 79 is in electronic communication with the mount assembly 40, the motion device 50, the encoder 78, the sensor tower 80, the LVDT 146, and die nozzle 196. The controller 79 includes a computer having an input/output interface, a central processor unit, a random access memory, i.e. RAM, and a read only memory, i.e. ROM. The input interface is electrically connected with the mount assembly 40, the motion device 50, the encoder 78, the sensor tower 80, and the LVDT 146. Signals from the LVDT 146 and the encoder 78 are fed into the computer through the input interface and are temporarily stored in the RAM. The ROM stores a program, i.e. first comparative software for calculating radial displacements of the upper 14 and lower 16 beads of the wheel 12 and reads out these programs from the ROM and various data from the RAM and carries out the calculation. The controller 79 includes a second comparative software for integrating a reference signal, i.e. phase angle over a 360 degree rotation of the wheel 12, generated by the encoder 78, and to determine a comparison with a previously stored value, i.e. the highest negative and the highest positive value with respect to the null position, generated by the LVDT 146. The second comparative software integrates the first and second signals and generates a third signal, i.e. determination of a median between the radial displacements of the upper 14 and lower 16 beads of the wheel 12. The third signal represents the average radial displacement of the upper 14 and lower 16 beads relative to the axis A. The third signal further directs the mount assembly 40 to rotate the wheel 12 in a way, wherein the aforementioned median between the upper 14 and lower 16 beads is placed right below the tool 190 for the mark to be placed on the upper bead 14. The comparative software generates a forth signal and translates the forth signal to the tool 190 for placing the mark.

During operation, the wheel 12 is located on the mount assembly 40 by abutting the wheel 12 against the opposing positioning bars 186. Once located, in the desired position, the wheel 12 is lowered onto the mount 12 and rested upon the spindle plate 44. The vacuum on the spring mount 42 then released allowing the spring mount 42 to spread outwardly, increasing its diameter to secure the wheel 12 to the mount 12. Once the wheel 12 is in position on the mount 12, the radial displacement measuring cycle is initiated and the wheel 12 is pivoted by the motor 48 as described above. The sensor tower 80 is moved to the wheel 12 by the carriage 150, whereby the vertical member 100 simultaneously engages the upper 14 and lower 16 beads of the wheel 12. The resilient device, i.e. spring 140, operably connected to the horizontal member 98, biases the vertical member 100 against the wheel 12 to ensure constant simultaneous contact of the vertical member 98 with the upper 14 and lower 16 beads during rotational cycle of the wheel 12. The rollers, i.e. feelers 124, 126, rotatably connected to the vertical member 100, translate motion of radially displaced upper 14 and lower 16 beads to the push rod 148 through the horizontal member 98 operably connected to the push rod 148. The push rod 148 is operably connected to the LVDT 146 and is movable to and from the LVDT 146 to determine two highest reading, positive and negative with respect to the central, i.e. null position determined by the LVDT 146. At the same time, the encoder 78 tracks and signals to the controller 79 the first signal, i.e. phase angle or segment of rotational movement of the wheel 12. The first comparative software of the controller 79 receives both the highest positive and the highest negative readings from the LVDT 146 and each reading of the segment of rotational movement from the encoder 78 to complement each of the highest negative and positive readings with the respective phase angle. The second comparative software averages the two readings with the respective phase angles to determine a median deviation, i.e. averaged point of the radial displacements between the upper 14 and lower 16 beads. When the median deviation is detected, the mount assembly 40 rotates the wheel 12 to position, whereby the median deviation is oriented below the die nozzle 196 of the tool 190. The controller 79 signals the die nozzle 196 to apply die onto the upper bead 14 of the wheel 12 at the location of the median deviation. After the median deviation has been marked with the die, the spring mount 42 is depressurized, thereby decreasing the diameter of the spring mount 42 allowing the wheel 12 to be removed from the assembly 10.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for measuring radial displacement of a wheel having first and second beads circumscribing an axis, said apparatus comprising:
a mount assembly for rotating the wheel around said axis;
a sensing device movable radially relative to said axis; and
a bead engaging element pivotably connected to said sensing device for simultaneously engaging the first and second beads and moving said sensing device radially relative to said axis as the first and second beads vary in radial distance from said axis around the wheel to detect the combined offset of the first and second beads from said axis for generating a first signal representing the average radial displacement of the first and second beads.

2. An apparatus as set forth in claim 1 further including said bead engaging element defined by a rigid bar.

3. An apparatus as set forth in claim 2 wherein said rigid bar is further defined by a pair of plates spaced from one another and having a core extending between said plates and equally spaced from said terminal ends.

4. An apparatus as set forth in claim 2 further including a pair of rollers each rotatably supported at the respective terminal ends of said plates for facilitating slidable engagement of said rollers with said first and second beads.

5. An apparatus as set forth in claim 4 further including a pin extending through said sensing device and said rigid bar for facilitating pivotable motion of said rigid bar relative to said sensing device.

6. An apparatus as set forth in claim 5 including a pair of bushings circumscribing said pin and disposed between said rigid bar and said sensing device radially relative to said pin for preventing radial disposition of said rigid bar relative to said sensing device.

7. An apparatus as set forth in claim 1 including a supporting element operably connected to said sensing device for facilitating slidable movement of said sensing device within said supporting element and with respect to said axis.

8. An apparatus as set forth in claim 7 including a resilient device cooperably connected to and extending between said supporting element and said sensing device for biasing said bead engaging element against the wheel.

9. An apparatus as set forth in claim 8 including a first sensor operably connected to said sensing device for responding to displacement of said sensing device relative to said supporting element in response to said combined offset of the first and second beads as the first and second beads vary in radial distance from said axis.

10. An apparatus as set forth in claim 9 including a first comparative software electronically connected to said first sensor for averaging said combined offset to generate said first signal representing the average radial displacement of the first and second beads.

11. An apparatus as set forth in claim 10 including a second sensor operably connected to said mount assembly for sensing a phase angle of rotation of said mount assembly for generating a second signal corresponding to the radial position of said combined offset of the first and second beads.

12. An apparatus as set forth in claim 11 including a second comparative software operably connected to said first and second sensors for integrating said first and second signals and generating a third signal.

13. An apparatus as set forth in claim 12 including an applicator operably connected to said apparatus for receiving said third signal directing said applicator to mark the wheel.

14. An apparatus for measuring radial displacement of a wheel having first and second beads each having first and second beads circumscribing an axis, said apparatus comprising:
a mount assembly for rotating the wheel around the axis;
a first device pivotably connected to a second device and movable with respect to the axis;
a first sensor for sensing said radial displacement of the wheel;
a second sensor for sensing a phase angle of rotation of said mount assembly for generating a second signal;
a controller for receiving and integrating said first and second signals; and
said second device having a first feeler cooperably connected to a second feeler, said first and second fillers simultaneously engaging the upper and lower beads for measuring radial displacements of the upper and lower beads, wherein said second device is operably connected to said first sensor thereby signaling said controller said radial displacements of the upper and lower beads.

15. An apparatus as set forth in claim 14 further including said second device defined by a rigid bar.

16. An apparatus as set forth in claim 15 further including said rigid bar defined by a pair of plates spaced from one another and having a core extending between said plates and equally spaced from said terminal ends.

17. An apparatus as set forth in claim 15 wherein each of said first and second feelers are further defined by a roller rotatably supported at the respective terminal ends of said plates for facilitating slidable engagement of said rollers with said first and second beads.

18. An apparatus as set forth in claim 17 further including a pin extending through said first device and said rigid bar for facilitating pivotable motion of said rigid bar relative to said first device.

19. An apparatus as set forth in claim 18 further including a pair of bushings circumscribing said pin and disposed between said rigid bar and said first device radially relative to said pin for preventing radial disposition of said rigid bar relative to said first device.

20. An apparatus as set forth in claim 1 including a supporting element operably connected to said first device for facilitating slidable movement of said first device within said supporting element and with respect to said axis.

21. An apparatus as set forth in claim 14 including a resilient device cooperably connected to and extending between said supporting element and said first device for biasing said second element against the wheel.

22. An apparatus as set forth in claim 14 wherein said first sensor is operably connected to said first device for responding to displacement of said first device relative to said supporting element in response to said combined offset of the first and second beads as the first and second beads vary in radial distance from said axis.

23. An apparatus as set forth in claim 14 including a first comparative software electronically connected to said first sensor for averaging said combined offset to generate said first signal representing the average radial displacement of the first and second beads.

24. An apparatus as set forth in claim 14 including a second comparative software operably connected to said first and second sensors for integrating said first and second signals and generating a third signal.

25. An apparatus as set forth in claim 14 including an applicator operably connected to said apparatus for receiving said third signal directing said applicator to mark the wheel.

26. An apparatus for rotating a workpiece, comprising:
a mount assembly having a first axis for rotating the workpiece about said axis;
a motion device having a second axis for generating a rotational force for rotating said mount assembly;
a belt engaged about said first and second axis for translating rotational force from said motion device to said mount assembly thereby rotating the workpiece; and
a pivoting device presenting a pivoting axis and operably connected to said motion device for pivoting said motion device with respect to said mount assembly about said pivoting axis thereby adjusting tension of said belt by pivotable movement of said motion device with respect to said mount assembly.

27. An apparatus as set forth in claim 26 wherein said pivoting device is further defined by a plate pivotable about said pivoting axis and extending therefrom to a distal end.

28. An apparatus as set forth in claim 27 wherein said plate is operably connected to said motion device.

29. An apparatus as set forth in claim 28 including a lever connected to said distal end of said plate for moving said plate to and from said mount device thereby adjusting tension of said belt.
